(19) United States
(12) Patent Application Publication
(10) Pub. No.: US 2011/0052138 A1
(43) Pub. Date: Mar. 3, 2011

(54) IMAGE RECORDING DEVICE, CAMERA, IMAGE REPRODUCTION DEVICE, IMAGE RECORDING METHOD, IMAGE REPRODUCTION METHOD, PROGRAM, AND INTEGRATED CIRCUIT

(76) Inventors: Takuma Chiba, Osaka (JP); Yukinaga Seki, Kyoto (JP); Kenjiro Tsuda, Osaka (JP); Hiroaki Shimazaki, Osaka (JP); Yuki Kobayashi, Osaka (JP); Tatsuro Juri, Osaka (JP); Katsuo Saigo, Hyogo (JP); Takashi Masuno, Osaka (JP)

(21) Appl. No.: 12/811,723

(22) PCT Filed: Dec. 26, 2008
(86) PCT No.: PCT/JP2008/004018

§ 371 Date: Jul. 6, 2010

(30) Foreign Application Priority Data
Jan. 7, 2008 (JP) 2008-000733

(51) Int. Cl. H04N 5/92

(52) U.S. Cl. 386/224; 386/E05.009

(57) ABSTRACT

An image recording device (100) which records an input image includes an image generating unit (120) which generates the input image based on input electric signal, an image transforming unit (130) which generates a group of first frames which can be independently reproduced, by extracting frames at a predetermined time interval from frames included in the input image generated by the image generating unit (120) and by arranging, in chronological order, the extracted frames, and to generate a group of second frames using frames that are not in the group of first frames but are in the frames included in the input image, an image coding unit (140) which (i) codes the group of first frames generated by the image transforming unit (130) and outputs a first stream, and (ii) codes the group of second frames generated by the image transforming unit (130) and outputs a second stream, and a recording unit (150) which records the first stream and the second stream coded by the image coding unit (140) on a recording medium.

### TECHNICAL FIELD

The present invention relates to an image recording device which records images, and an image reproduction device which reproduces the recorded images.

### BACKGROUND ART

Image recording devices such as camcorders include imaging devices such as Charge Coupled Devices (CCD), transfer images generated by the imaging devices, code the images, and records the coded images. When the image recording device performs high-speed capturing, it is necessary to speed up image transfer speed from the imaging device, coding speed, and image recording process. This causes a problem of increased cost for the image recording device. In order to solve this problem, an image recording device which performs high-speed capturing without speeding up the image transfer speed from the imaging device, coding speed and image recording process has been proposed (for example, see Patent Literature 1).

FIG. 19 illustrates the image recording device according to Patent Literature 1.

When capturing at normal speed, the image recording device transfers the frames 1 and 2 from an imaging device at a predetermined frame rate, codes the frames, and records the coded frames 1 and 2. On the other hand, when capturing at high speed, the image recording device changes the size of the frames 1 to 4 to a size of sub screen, divide the screen and multiplex the frames, and records the image generated by the division and multiplexing as a regular image. More specifically, when capturing at 4× speed, the size of the frames 1 to 4 that are captured at high speed are changed to the size of sub screen which is one quarter in size, divides and multiplexes four successive ¼ sized sub screens into one image, and records the one image as a regular image. This allows high-speed capturing without speeding up image transfer speed from the imaging device, coding process speed, and image recording process. [Patent Literature 1] Japanese Patent No. 2718409

### DISCLOSURE OF INVENTION

### Problems that Invention is to Solve

However, the image recording device according to Patent Literature 1 records the frames after reducing their size, which causes a problem of lowered resolution and degradation in image quality.

The present invention has been conceived to solve the problem, and it is an object of the present invention to provide an image recording device that can lower image transfer speed from the imaging device, coding speed, and image recording speed that are necessary for high-speed capturing, and an image reproduction device.

### Means to Solve the Problems

An image recording device according to the present invention is An image recording device which records an input image, the image recording device including: an image generating unit which generates the input image based on input electric signal; an image transforming unit which generates a group of first frames which can be independently reproduced, by extracting frames at a predetermined time interval from frames included in the input image generated by the image generating unit and by arranging, in chronological order, the extracted frames, and generates a group of second frames using frames that are not in the group of first frames but are in the frames included in the input image; an image coding unit which (i) codes the group of first frames generated by the image transforming unit and outputs a first stream, and (ii) codes the group of second frames generated by the image transforming unit and outputs a second stream; and a recording unit which records the first stream and the second stream coded by the image coding unit on a recording medium. With this, regular reproduction can be performed by decoding and reproducing only the first stream, and slow reproduction can be performed by decoding both the first stream and the second stream and reproducing the first and second streams.

In addition, the image transforming unit may arrange, in chronological order, synthesized frames to generate the group of second frames, each of the synthesized frames being synthesized from pixels extracted from different regions of frames that are between temporally adjacent frames of the group of first frames. With this, the first stream (main stream) at high resolution and the second stream (sub stream) at low resolution are recorded. This allows the reproduction of the high-resolution main stream at the time of regular reproduction, and reconstruction of a clear image using the high-resolution main stream and the low-resolution sub stream and reproduction of the reconstructed stream at the time of slow reproduction.

In addition, the image transforming unit may synthesize each of the synthesized files from pixels that are not skipped when skipping pixels in the frames at least one of per line and per column. As such, simply skipping pixels per line and/or per column allows transforming the frames other than the frames at the predetermined time interval into the synthesized frames.

In addition, the input image is a progressive image. Although the present invention is applicable to both progressive images and interlaced images, the embodiment described above is particularly effective for the progressive images.

In addition, the image transforming unit may (i) extract N frames for each N frames from the frames, where N being a natural number, to synthesize each of first synthesized frames from the N frames that are temporally successive, and arrange, in chronological order, the first synthesized frames to generate the group of first frames, and (ii) synthesize each of second synthesized frames from N temporally successive frames among frames that are not in the group of first frames but are in the frames included in the input image, and arrange, in chronological order, the second synthesized frames to generate the group of second frames. This also allows reducing the image transfer speed from the imaging device, coding speed, and image recording speed that are necessary for capturing at high speed without degrading image quality significantly.

In addition, the input image may be an interlaced image. Although the present invention is applicable to both progressive images and interlaced images, the embodiment described above is particularly effective for the interlaced images.

In addition, the group of first frames and the group of second frames may have an identical screen size and an identical frame rate. With this, it is possible to record the streams of the same coding format on the recording medium.

A camera according to the present invention includes the image recording device described above and an imaging unit configured to convert light into electric signals and output the electric signals to the image generating unit.

In addition, the image transforming unit may arrange, in chronological order, synthesized frames to generate the group of second frames, each of the synthesized frames being synthesized from pixels extracted from different regions of frames that are between temporally adjacent frames of the group of first frames.

In addition, the camera may further include a read-out control unit which controls the imaging unit to extract only electric signals corresponding to pixels composing the synthesized frame, from each of frames that are not in the group of first frames but are in the frames included in the input image. This reduces the pixel to be read for generating each of the frames, thereby reducing the image transfer speed from the imaging unit.

An image reproduction device according to the present invention is an image reproduction device which reproduces the image recorded by the image recording device described above, the image reproduction device including: a reproduction mode specifying unit which specifies either regular reproduction or slow reproduction as a reproduction mode; a read-out unit which reads a stream from the recording medium; a decoding unit which decodes the stream read by the read-out unit; and an image reconstructuring unit which reproduces a group of frames decoded by the decoding unit, in which, when the reproduction mode specifying unit specifies regular reproduction, the read-out unit reads the first stream recorded on the recording medium, the decoding unit decodes the first stream read by the read-out unit, and the image reconstructuring unit reproduces the group of first frames decoded by the decoding unit without any change, and when the reproduction mode specifying unit specifies slow reproduction, the read-out unit reads both the first stream and the second stream recorded on the recording medium, the decoding unit separately decodes the first stream and the second stream that are read by the read-out unit, and the image reconstructing unit arranges, in chronological order, the frames included in the group of first frames and the group of second frames that are decoded by the decoding unit, and reproduces the arranged frames.

An image recording method according to the present invention is an image recording method for recording an input image, the image recording method including: generating the input image based on input electric signal; generating a group of first frames which can be independently reproduced, by extracting frames at a predetermined time interval from frames included in the input image generated by the image generating unit and by arranging, in chronological order, the extracted frames, and generating a group of second frames using frames that are not in the group of first frames but are in the frames included in the input image; (i) coding the group of first frames generated by the image transforming unit and outputting a first stream, and (ii) coding the group of second frames generated in the generating, and outputting a second stream; and recording the first stream and the second stream coded in the generating on a recording medium.

An image reproduction method according to the present invention is an image reproduction method for reproducing the image recorded by the image recording device described above, the image reproduction method including: specifying either regular reproduction or slow reproduction as a reproduction mode; reading a stream from the recording medium; decoding the stream read in the reading; and reproducing a group of frames decoded in the decoding, in which, when regular reproduction is specified in the specifying, the first stream recorded on the recording medium is read, the first stream read in the reading is decoded, the group of first frames decoded in the decoding is reproduced without any change, and when slow reproduction is specified in the specifying, both the first stream and the second stream recorded on the recording medium are read, the first stream and the second stream that are read by the read-out unit are decoded separately, and the frames included in the group of first frames and the group of second frames that are decoded in the decoding are arranged in chronological order and the arranged frames are reproduced.

A program according to the present invention is a program causing a computer to record an input image, the program causing the computer to execute: generating the input image based on input electric signal; generating a group of first frames which can be independently reproduced, by extracting frames at a predetermined time interval from frames included in the input image generated by the image generating unit and by arranging, in chronological order, the extracted frames, and generating a group of second frames using frames that are not in the group of first frames but are in the frames included in the input image; (i) coding the group of first frames generated by the image transforming unit and outputting a first stream, and (ii) coding the group of second frames generated in the generating, and outputting a second stream; and recording the first stream and the second stream coded in the generating on a recording medium.

A program according to the present invention is a program causing a computer to reproduce the image recorded by the image recording device described above, the program causing the computer to execute: specifying either regular reproduction or slow reproduction as a reproduction mode; reading a stream from the recording medium; decoding the stream read in the reading; and reproducing a group of frames decoded in the decoding, in which, when regular reproduction is specified in the specifying, the first stream recorded on the recording medium is read, the first stream read in the reading is decoded, the group of first frames decoded in the decoding is reproduced without any change, and when slow reproduction is specified in the specifying, both the first stream and the second stream recorded on the recording medium are read, the first stream and the second stream that are read by the read-out unit are decoded separately, and the frames included in the group of first frames and the group of second frames that are decoded in the decoding are arranged in chronological order and the arranged frames are reproduced.

An integrated circuit according to the present invention is an integrated circuit which codes an input image, the integrated circuit including: an image transforming unit which generates a group of first frames which can be independently reproduced, by extracting frames at a predetermined time interval from frames included in the input image and by arranging, in chronological order, the extracted frames, and to generate a group of second frames using frames that are not in the group of first frames but are in the frames included in the input image; an image coding unit which (i) codes the group of first frames generated by the image transforming unit and outputs a first stream, and (ii) codes the group of second frames generated by the image transforming unit and outputs a second stream.

An integrated circuit according to the present invention is an integrated circuit which reproduces the image recorded by the image recording device described above, the integrated circuit including: a decoding unit which decodes an input stream; and an image reconstructuring unit which reproduces a group of frames decoded by the decoding unit, in which, when regular reproduction is specified upon input of the first stream recorded on the recording medium, the decoding unit decodes the first stream read by the read-out unit, the image reconstructuring unit reproduces the group of first frames decoded by the decoding unit without any change, and when slow reproduction is specified upon input of the first stream and a second stream that are recorded on the recording medium, the decoding unit separately decodes the first stream and the second stream that are read by the read-out unit, and the image reconstructing unit arranges, in chronological order, the frames included in the group of first frames and the group of second frames that are decoded by the decoding unit, and reproduces the arranged frames.

Note that, the present invention can be implemented not only as an image recording device and an image reproduction device, but also as an integrated circuit which implements the function of the image recording device and the image reproduction device, and as a program which causes a computer to execute the functions. Needless to say, such a program can be distributed via a recording medium such as CD-ROM and a transmission medium such as the Internet.

### EFFECTS OF THE INVENTION

As described above, according to the present invention, the input image is divided into first and second streams and recorded on a recording medium. Thus, it is possible to implement an image recording device which lowers the image transfer speed from the imaging device, the coding speed, and the image recording speed that are necessary for high-speed capturing without significantly degrading image quality.

### BRIEF DESCRIPTION OF DRAWINGS

FIG. 1A illustrates the overview of an image recording device according to the first embodiment of the present invention.

FIG. 1B illustrates the overview of an image reproduction device according to the first embodiment of the present invention.

FIG. 2 is a block diagram of the image recording device according to the first embodiment of the present invention.

FIG. 3 illustrates an image transform method according to the first embodiment of the present invention.

FIG. 4 illustrates an image transform procedure according to the first embodiment of the present invention.

FIG. 5 is a block diagram of the image reproduction device according to the first embodiment of the present invention.

FIG. 6 illustrates an image reconstruction method according to the first embodiment of the present invention.

FIG. 7 is a flowchart illustrating an image reconstruction procedure according to the first embodiment of the present invention.

FIG. 8 illustrates an image transform method according to the second embodiment of the present invention.

FIG. 9 illustrates an image reconstruction method according to the second embodiment of the present invention.

FIG. 10 illustrates an image transform method according to the third embodiment of the present invention.

FIG. 11 illustrates an image reconstruction method according to the third embodiment of the present invention.

FIG. 12 illustrates an image transform method according to the fourth embodiment of the present invention.

FIG. 13 illustrates an image reconstruction method according to the fourth embodiment of the present invention.

FIG. 14 is a block diagram of the image recording device according to the fifth embodiment of the present invention.

FIG. 15 is a block diagram of the image recording device according to the sixth embodiment of the present invention.

FIG. 16 illustrates an example of skipping pixels according to the present invention.

FIG. 17 illustrates an example of image recording integrated circuit according to an embodiment of the present invention.

FIG. 18 illustrates an example of image reproduction integrated circuit according to an embodiment of the present invention.

FIG. 19 is a diagram for explaining an image recording device according to Patent Literature 1.

### NUMERICAL REFERENCES

100 Image recording device
110 Imaging device
120 Image generating unit
130 Image transforming unit
140 Image coding unit
141, 142 H.264 image coding unit
150 Recording unit
160 Read-out control unit
170, 250 LSI
200 Image reproduction device
210 Reproduction mode specifying unit
220 Image decoding unit
230 Read-out unit
240 Image reconstructing unit
300 Recording medium

### BEST MODE FOR CARRYING OUT THE INVENTION

The following describes embodiments of the present invention in detail with reference to the drawings.

### First Embodiment

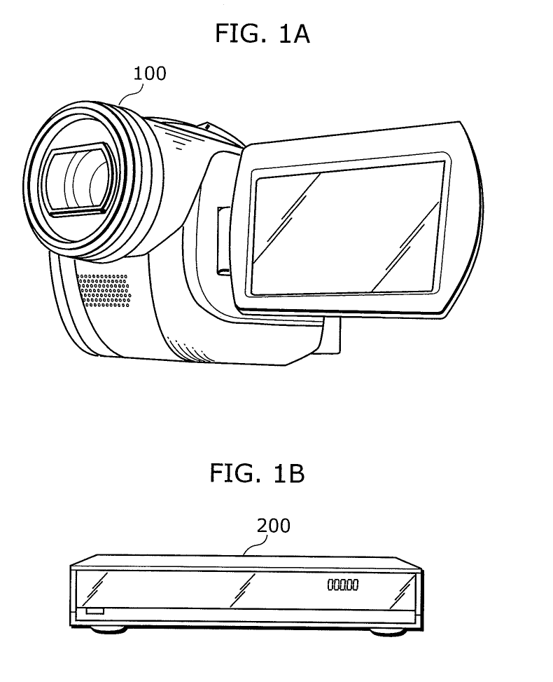

FIGS. 1A and 1B illustrate overviews of an image recording device 100 and an image reproduction device 200 according to the first embodiment of the present invention, respectively. For example, the image recording device 100 is applicable to a video camera which records captured images on a Digital Versatile Disc (DVD) or a Blu-ray Disc (BD). Furthermore, the image reproduction device 200 is applicable to a DVD player which reads the images recorded on the recording medium and reproduces the images, as illustrated in FIG. 1B. Note that, the video camera illustrated in FIG. 1A may include the image recording device 100 and the image reproduction device 200.

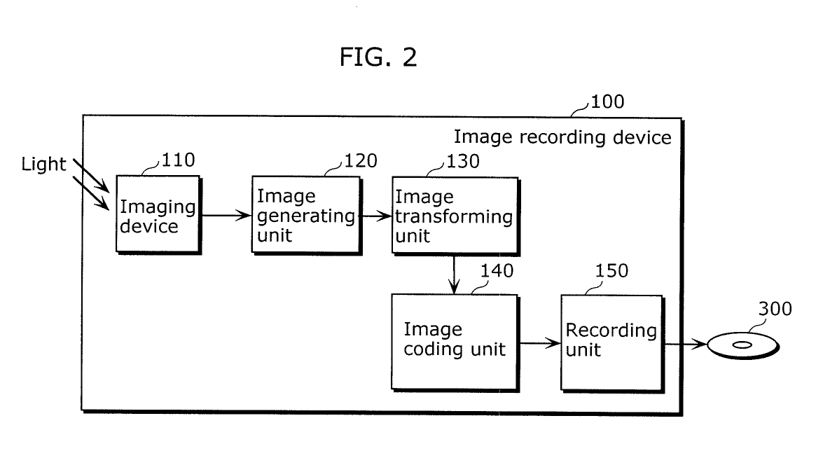

FIG. 2 is a block diagram of the image recording device 100 according to the first embodiment of the present invention.

The image recording device 100 records images, and in terms of the function, includes an imaging device 110, an image generating unit 120, an image transforming unit 130, an image coding unit 140, and a recording unit 150, as illustrated in FIG. 2. Note that, the image recording device 100 of the present invention may include an input terminal which inputs the electric signal which is a source of an input image from outside.

The imaging device 110 converts incident light into electric signal and outputs the electric signal. The image generating unit 120 generates the input image based on the electric signal converted by the imaging device 110. The generated image is an image with a distinction between angles of view and interlace/progressive, such as 1920×1080 progressive, 1920×1080 interlaced, and 1280×720 progressive.

The image transforming unit 130 transforms frames at a predetermined interval (for example, intervals at the time of capturing at regular speed) into frames at the first resolution, among the frames included in the input image generated by the image generating unit 120 and outputs the transformed frames. Furthermore, the image transforming unit 130 transforms frames other than the frames at the predetermined interval (for example, intervals at the time of capturing at regular speed) among the frames included in an input image generated by the image generating unit 120 into frames at second resolution, and outputs synthesized frames that are obtained by synthesizing the frames at second resolution. The second resolution is lower than the first resolution. When the frames at the first resolution are arranged in chronological order, a group of first frames that can be independently reproduced is generated. On the other hand, when the synthesized frames are arranged in chronological order, a group of second frames is generated.

The image transforming unit 130 may output the input image without any change. For example, in the first embodiment, the frames at the predetermined time interval (for example, the interval at the time of capturing at regular speed) are output as originally input, without changing the resolution.

The image coding unit 140 codes the group of first frames output from the image transforming unit 130 and outputs the first stream (hereafter also referred to as “main stream” or “stream A”), and codes the group of second frames output from the image transforming unit 130 and outputs the second stream (hereafter also referred to as “sub stream” or “stream B”. Although the coding method is not particularly limited, coding methods such as H.264/AVC are used. The recording unit 150 records the stream A and stream B output from the image coding unit 140 on a recording medium 300 such as DVD and BD.

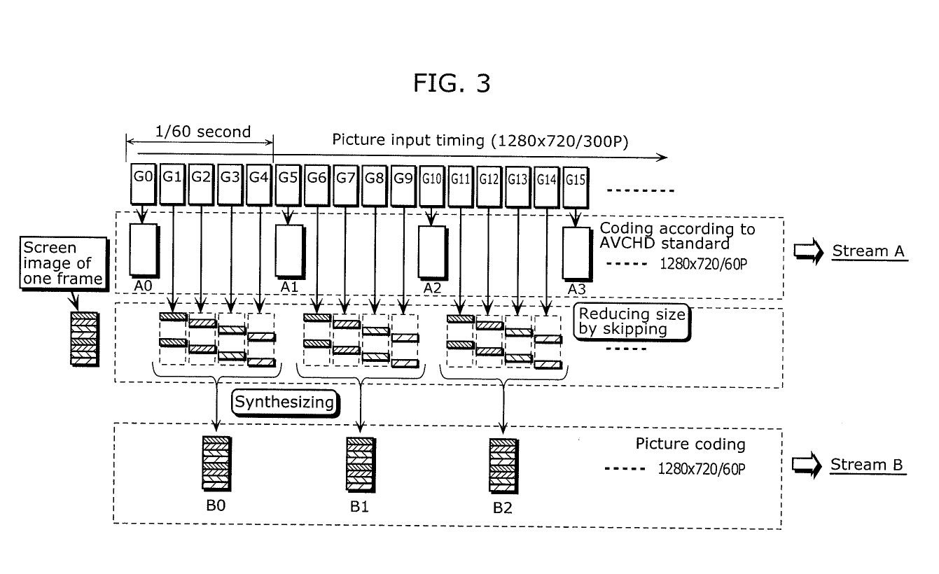

FIG. 3 illustrates an image transforming method according to the first embodiment of the present invention.

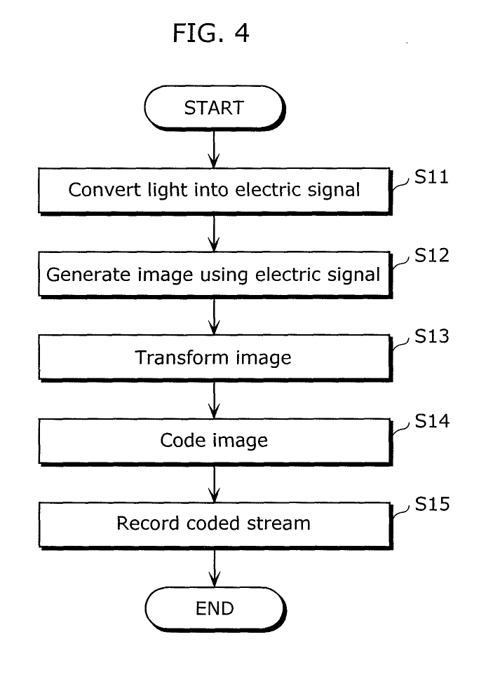

Here, a case where the imaging device 110 and the image generating unit 120 generate input frames G0, G1, G2 . . . G13, G14, G15 . . . shall be described (see FIG. 4, S11 and S12). The input image is a progressive image of 1280×720, and when 300 images are generated per second, it is denoted as 1280×720/300p.

First, the image transforming unit 130 transforms the input frames G0, G1, G2 . . . G13, G14, G15 . . . (FIG. 4, S13). Here, among the input frames G0, G1, G2 . . . G13, G14, G15 . . . , the input frames G0, G5, G10, G15 . . . are frames at the time intervals at the time of capturing at regular speed, and the input frames G1, G2, G3, G4, G6, G7, G8, G9 . . . are frames other than the frames at the time intervals at the time of capturing at regular speed.

Thus, the image transforming unit 130 outputs the group of first frames A0, A1, A2, A3 . . . , without transforming the input frames G0, G5, G10, G15 . . . Furthermore, the image transforming unit 130 synthesizes the input frames G1, G2, G3, G4, G6, G7, G8, G9 . . . , and outputs the synthesized frames as the synthesized frames B0, B1, B2, B3 . . . , constituting the group of second frames.

More specifically, the pixel lines 0, 4, 8 . . . of the input frame G1, the pixel lines 1, 5, 9 . . . of the input frame G2, the pixel lines 2, 6, 10 . . . of the input frame G3, and the pixel lines 3, 7, 11 . . . of the input frame G4 are used for generating a synthesized frame B0. Furthermore, the pixel lines 0, 4, 8 . . . of the input frame G6, the pixel lines 1, 5, 9 . . . of the input frame G7, the pixel lines 2, 6, 10 . . . of the input frame G8, and the pixel lines 3, 7, 11 . . . of the input frame G9 are used for generating a synthesized frame B1. Synthesized frames B2, B3 . . . are generated in the same manner.

Here, the group of first frames A0, A1, A2, A3 . . . , and the group of second frames B0, B1, B2, B3 . . . are both moving pictures of 1280×720/60p. In other words, the frame size and the frame rate of the group of first frames and the group of second frames are identical.

Subsequently, the image coding unit 140 codes the moving picture generated by the image transforming unit 130 (FIG. 4, S14). More specifically, the group of first frames A0, A1, A2, A3 . . . is coded as one moving picture to generate the stream A. Furthermore, the group of second frames B0, B1, B2, B3 . . . is also coded as one moving picture to generate the stream B.

Finally, the recording unit 150 records the stream A and stream B generated by the image coding unit 140 on the recording medium 300 (FIG. 4, S15).

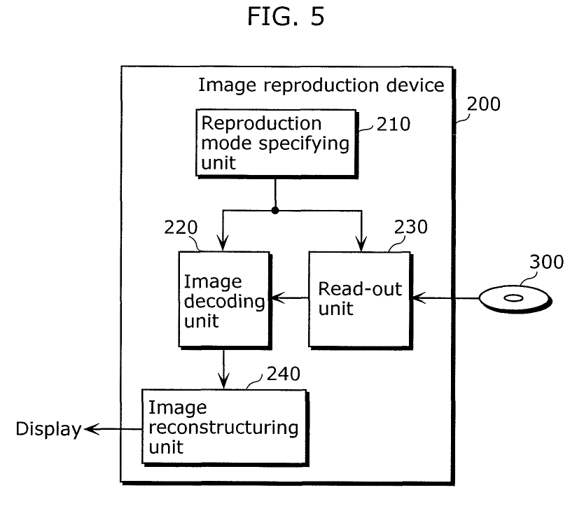

FIG. 5 is a block diagram of the image reproduction device 200 according to the first embodiment of the present invention.

The image reproduction device 200 according to the first embodiment of the present invention reproduces images, and in terms of function, includes a reproduction mode specifying unit 210, an image decoding unit 220, a read-out unit 230, and an image reconstructing unit 240, as illustrated in FIG. 5. Here, the description shall be made for a case where the stream A and stream B at 1280×720/60p generated by the image recording device 100 are recorded on the recording medium 300.

The reproduction mode specifying unit 210 specifies either regular reproduction or slow reproduction as a reproduction mode. When the regular reproduction is specified by the reproduction mode specifying unit 210, the read-out unit 230 reads the stream A recorded on the recording medium 300. On the other hand, when slow reproduction is specified by the reproduction mode specifying unit 210, the read-out unit 230 reads the stream A and stream B recorded on the recording medium 300.

When regular reproduction is specified by the reproduction mode specifying unit 210, the image decoding unit 220 decodes the stream A read by the read-out unit 230. On the other hand, when slow reproduction is specified by the reproduction mode specifying unit 210, the image decoding unit 220 decodes the stream A and stream B read by the read-out unit 230.

When regular reproduction is specified by the reproduction mode specifying unit 210, the image reconstructing unit 240 reproduces the stream A decoded by the image decoding unit 220 without any change to generate the regular reproduction image. On the other hand, when slow reproduction is specified by the reproduction mode specifying unit 210, the image reconstructuring unit 240 reconstructs images with the same angles of view and frame counts as the input image using the stream A and stream B decoded by the image decoding unit 220, reproduces the reconstructed image to generate the slow reproduction video. In other words, the groups of first frames and second frames that are obtained by decoding the stream A and stream B, respectively, are rearranged in chronological order and reproduced.

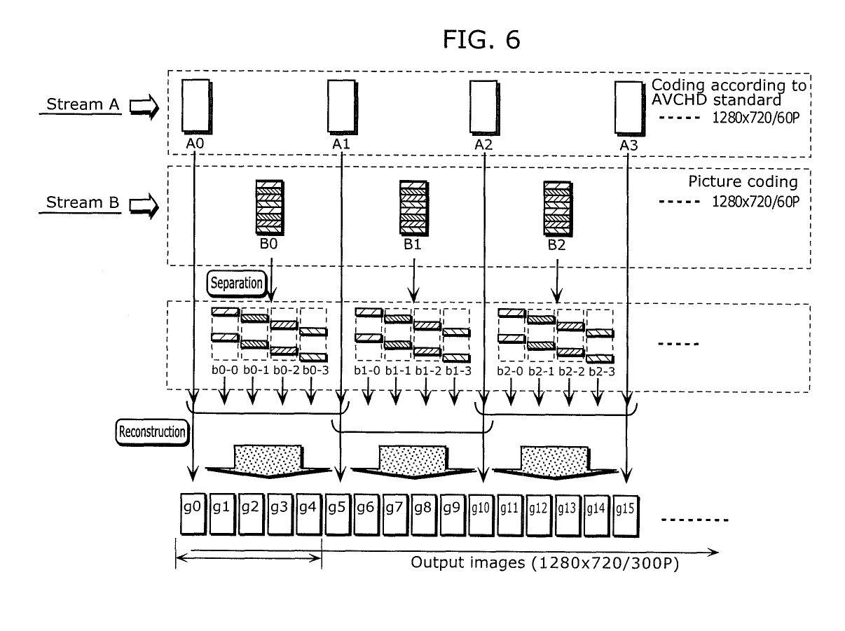

FIG. 6 illustrates an image reconstructuring method according to the first embodiment of the present invention.

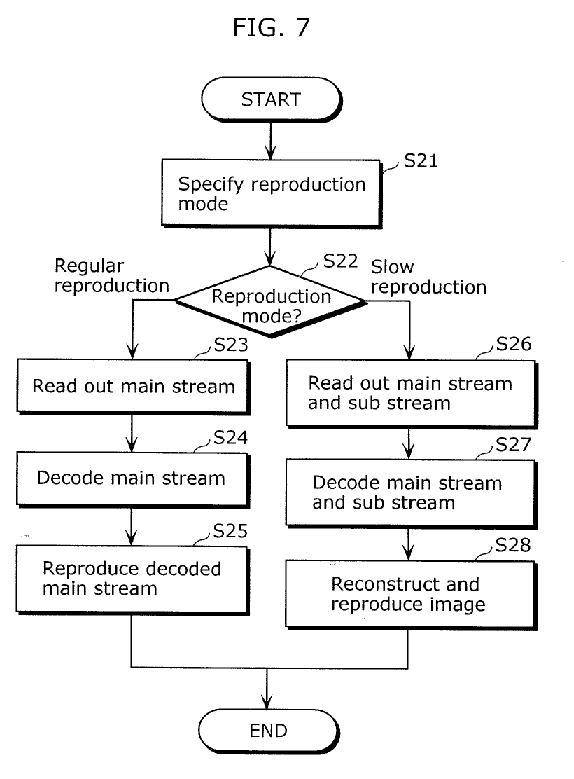

Here, it is assumed that the reproduction mode specifying unit 210 specifies slow reproduction. When the slow reproduction is specified, the stream A and stream B illustrated in FIG. 3 are read from the recording medium 300 by the read-out unit 230, decoded by the image decoding unit 220, and reconstructed by the image reconstructing unit 240 as described below (FIG. 7, S21 to S22 to S26 to S27 to S28).

First, the image reconstructing unit 240 determines the group of first frames A0, A1, A2 . . . that are obtained by decoding the stream A as the output frames g0, g5, g10 . . . without any change. Furthermore, the image reconstructing unit 240 separates the synthesized frame B0 obtained by decoding the stream B, arranges the pixel lines in chronological order of recording to generate intermediate frames b0-0, b0-1, b0-2, and b0-3. The intermediate frame b0-0 is generated by the pixel lines 0, 4, 8 . . . of the synthesized frame B0, the intermediate frame b0-1 is generated by the pixel lines 1, 5, 9 . . . of the synthesized frame B0, the intermediate frame b0-2 is generated by the pixel lines 2, 6, 10 . . . of the synthesized frame B0, and the intermediate frame b0-3 is generated by the pixel lines 3, 7, 11 and so on.

Furthermore, the image reconstructing unit 240 generates pixels that were skipped at the time of recording the image using the four intermediate frames b0-0, b0-1, b0-2 b0-3 and the group of first frames A0 and A1, using interpolation of the pixels and super resolution technology and others. The intermediate frames b1-0, b1-1, b1-2, b1-3 are generated from the synthesized frame B1 in the same manner, and the output frames g6, g7, g8, and g9 are reconstructed from the intermediate frames and the group of first frames A1 and A2 to reconstruct the output frames g6, g7, g8, and g9. The output frames g11, g12 . . . are reconstructed in the same manner.

The output frames g0, g1, g2, g3 . . . are arranged in chronological order to generate the image with 1280×720 pixels; in addition, it is the video captured at high speed with 300 frames per second. When 60 frames of the video is displayed per second, a ⅕ slow reproduction image is reproduced. The slow reproduction image is clear and smooth.

Note that, when regular reproduction is specified by the reproduction mode specifying unit 210, the stream A recorded on the recording medium 300 is read by the read-out unit 230, decoded by the image decoding unit 220, and reproduced by the image reconstructing unit 240 without any change, thereby generating a regular reproduction video (FIG. 7, S21 to S22 to S23 to S24 to S25).

As such, according to the first embodiment, it is possible to reduce the image transfer speed from the imaging device, coding speed, and the image recording speed that are necessary for capturing at high speed without significantly degrading image quality. In other words, the stream A at high resolution and the stream B at low resolution are recorded. This allows reproduction of the high-definition stream A at the time of regular reproduction, and reproduction of the clear image using the high-resolution stream A and low-resolution stream B at the time of slow reproduction.

### Second Embodiment

In the second embodiment, an image transform method different from the first embodiment is used. More specifically, although a method for skipping pixels per line is used in the first embodiment, a method for skipping pixels per line and column is used in the second embodiment. The following describes the image transform method according to the second embodiment focusing on the differences from the first embodiment.

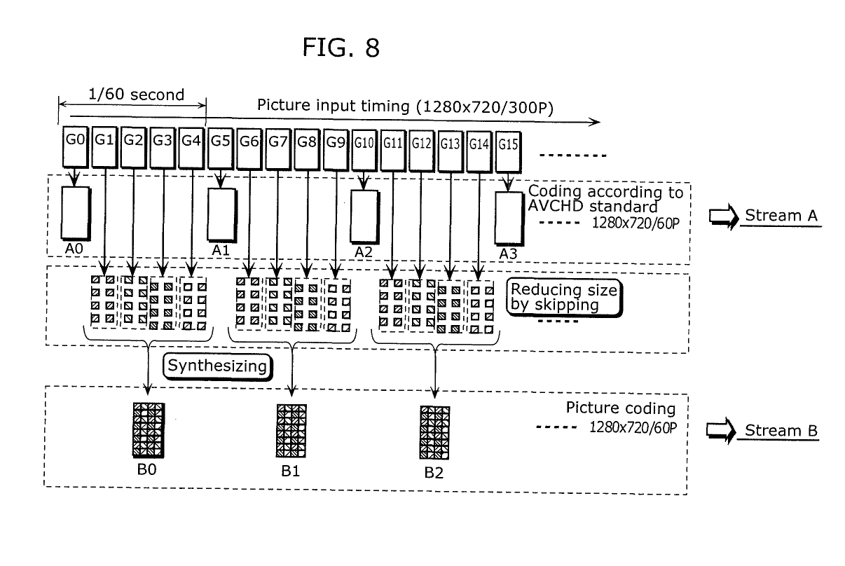

FIG. 8 illustrates an image transforming method according to the second embodiment of the present invention.

As illustrated in FIG. 8, the image transform method according to the second embodiment is similar to the image transform method according to the first embodiment (see FIG. 3) except for the difference in the transform method in the image transforming unit 130 of the synthesized frames B0, B1, B2 . . . , constituting the group of second frames. More specifically, the synthesized image B0 is generated using the pixels in even pixel lines and even pixel columns of the input frame G1, the pixels in even pixel lines and odd pixel columns of the input frame G2, the pixels in odd pixel lines and even pixel columns of the input frame G2, and the pixels in the odd pixel lines and odd pixel columns of the input frame G4. The same applies to the other synthesized frames B1, B2, B3 and others.

In the second embodiment, an image reconstructuring method different from the first embodiment is used. The following describes the image reconstructuring method according to the second embodiment focusing on the differences from the first embodiment.

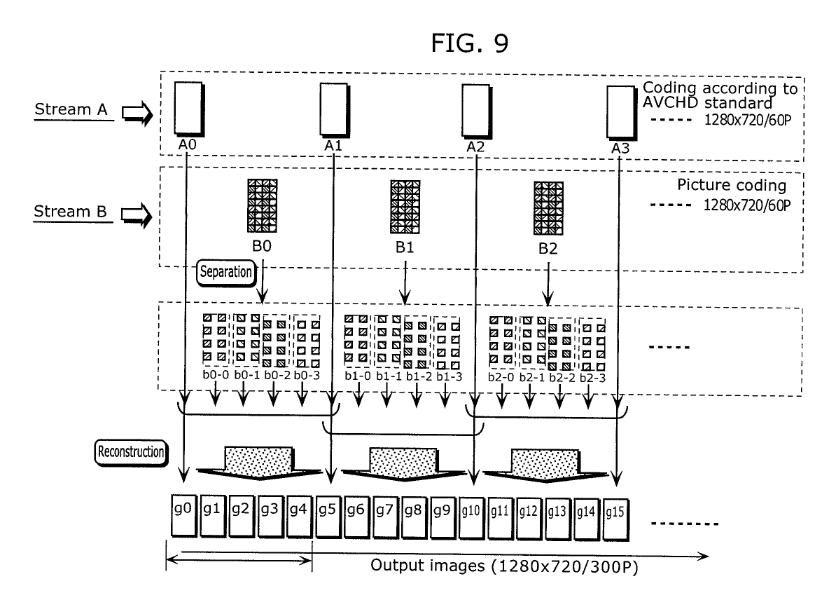

FIG. 9 illustrates an image reconstructuring method according to the second embodiment of the present invention.

As illustrated in FIG. 9, the image reconstructuring method according to the second embodiment is similar to the reconstructuring method according to the first embodiment (see FIG. 6) except that the method for generating the intermediate frames b0-0, b0-1, b0-2, b0-3 in the image reconstructing unit 240 is different. More specifically, the intermediate frame b0-0 is generated from the pixel lines 0, 2, 4 of the synthesized frame B0, and the pixel columns 0, 2, 4 of the synthesized frame B0. Furthermore, the intermediate frame b0-1 is generated from the pixel lines 0, 2, 4 . . . and the pixel columns 1, 3, 5 of the synthesized frame B0. Furthermore, the intermediate frame b0-2 is generated from the pixel lines 1, 3, 5 . . . and the pixel lines 0, 2, 4 of the synthesized frame B0. Furthermore, the intermediate frame b0-3 is generated from the pixel lines 1, 3, 5 . . . and the pixel columns 1, 3, 5 of the synthesized frame B0. The same applies to the intermediate frames b1-0, b1-1, b1-2, and b1-3.

As described above, although an image transform method and an image reconstructuring method different from the first embodiment are used in the second embodiment, the same effect as the first embodiment can be achieved. In other words, it is possible to reduce the image transfer speed from the imaging device, coding speed, and image recording speed that are necessary for capturing at high speed.

### Third Embodiment

In the first embodiment, an example using a progressive image is described. In the third embodiment, an example using an interlaced image shall be described. The following describes the structure of the image recording device 100 and the image reproduction device 200 according to the third embodiment focusing on the differences from the first embodiment.

The image transforming unit 130 in the second embodiment extracts N (N is a natural number. N=2 in the third embodiment) frames from the frames included in the input image, arranges first synthesized frames that are obtained by synthesizing N temporally successive frames to generate the group of first frames. At the same time, the second synthesized frames generated by synthesizing N temporally successive frames among the frames not included in the group of first frames are arranged in chronological order to generate the group of second frames.

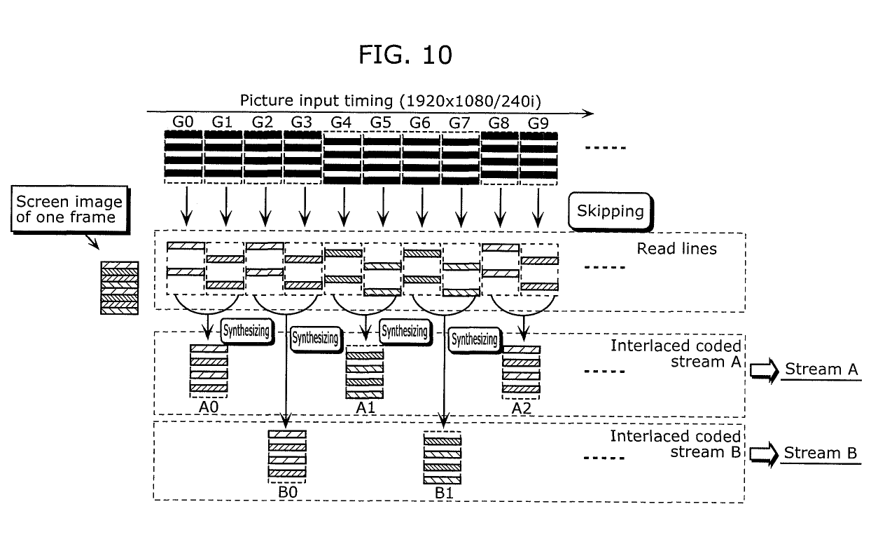

FIG. 10 illustrates an image reconstructuring method according to the third embodiment of the present invention.

Here, a case where the imaging device 110 and the image generating unit 120 generate input frames G0, G1, G2 . . . G7, G8, G9 . . . shall be described. The input image is an interlaced image of 1920×1080/240i. Note that the description shall be made assuming that the input frames G0, G1, G2, and G3 are images in even lines, and the input frames G4, G5, G6, and G7 are images in odd lines.

First, the image transforming unit 130 transforms the input frames G0, G1, G2 . . . G7, G8, G9, and so on. In other words, the image transforming unit 130 generates the first synthesized frame A0 using the pixel lines 0, 4, 8 . . . of the input frame G0 and the pixel lines 2, 6, 10 . . . of the input frame G1. Similarly, the image transforming unit 130 generates the second synthesized frame B0 using the pixel lines 0, 4, 8 . . . of the input frame G2 and the pixel lines 2, 6, 10 . . . of the input frame G3. Furthermore, the image transforming unit 130 generates the first synthesized frame A1 using the pixel lines 1, 5, 9 . . . of the input frame G4 and the pixel lines 3, 7, 11 . . . of the input frame G5. Similarly, the image transforming unit 130 generates the second synthesized frame B1 using the pixel lines 1, 5, 9 . . . of the input frame G6 and the pixel lines 3, 7, 11 . . . of the input frame G7.

Repeating the process allows extracting of input frames G0, G1, G4, G5 . . . for each two input frames of G0, G1, G2 . . . G7, G8, G9 . . . , and generating the group of first frames A0, A1, A2 . . . generated by arranging the first synthesized frame A0 obtained by synthesizing two input frames G0 and G1 that are temporally successive and the synthesized frame A1 obtained by synthesizing the two input frames G4 and G5.

Similarly, the group of second frames B0, B1, B2 that is obtained by arranging the second synthesized frame B0 obtained by synthesizing the two temporally successive input frames G2 and G3 among the input frames G2, G3, G6, G7 . . . that are not included in the group of first frames, and the second synthesized frame B1 obtained by synthesizing the two input frames G6 and G7 in chronological order is generated.

Note that, the group of first frames and the group of second frames share the same size and frame rate.

Subsequently, the image coding unit 140 codes the moving picture generated by the image transforming unit 130. More specifically, the group of first frames A0, A1, A2 . . . is coded as one moving picture to generate the stream A. Furthermore, the group of second frames B0, B1, B2 . . . is coded as a successive moving picture to generate the stream B. The stream A and stream B constitutes a general high-definition video at 1920×1080/60i. Finally, the recording unit 150 records the stream A and stream B generated by the image coding unit 140 on the recording medium 300.

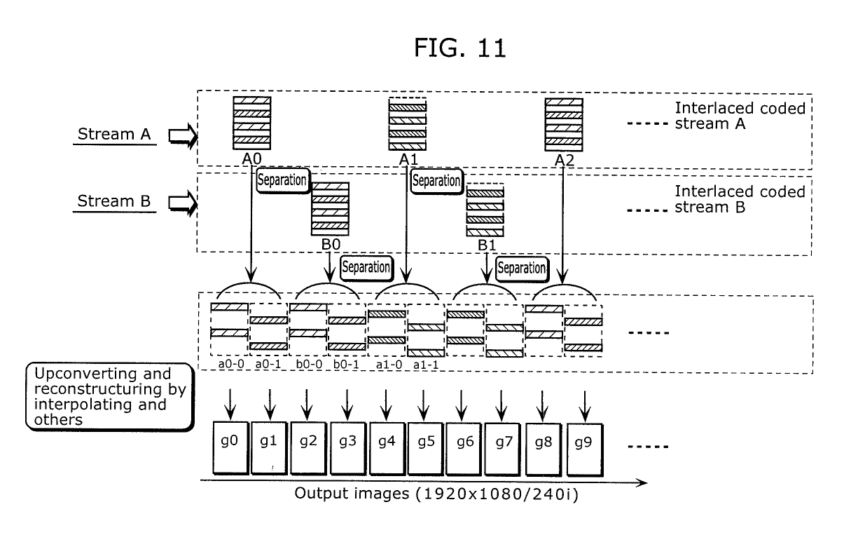

FIG. 11 illustrates an image reconstructuring method according to the third embodiment of the present invention.

Here, it is assumed that the reproduction mode specifying unit 210 specifies slow reproduction. When slow reproduction is specified, the stream A and stream B illustrated in FIG. 10 are read from the recording medium 300 by the read-out unit 230, decoded by the image decoding unit 220, and reconstructed by the image reconstructing unit 240 as described below.

First, the image reconstructing unit 240 separates the first synthesized frame A0 generated by decoding the stream A, and generates the intermediate frames a0-0 and a0-1 by arranging the pixels lines in the order of the input picture. The intermediate frame a0-0 is generated from the pixel lines 0, 4, 8 . . . of the first synthesized frame A0, and the intermediate frame a0-1 is generated by the pixel lines 2, 6, 10 . . . of the first synthesized frame A0. Similarly, the second synthesized frame B0 generated by decoding the stream B is separated to generate the intermediate frames b0-0, and b0-1. Furthermore, the first synthesized frame A1 is separated to generate the intermediate frames a1-0 and a1-1. The intermediate frame a1-0 is generated from the pixel lines 1, 5, 9 . . . of the first synthesized frame A1, and the intermediate frame a1-1 is generated by the pixel lines 3, 7, 11 . . . of the first synthesized frame A1.

Next, the image reconstructing unit 240 reconstructs the output frames g0, g1, g2, g3 . . . from the intermediate frames a0-0, a0-1, b0-0, b0-1, a1-0 . . . using pixel interpolation, super resolution technology and others. The output frames g0, g1, g2, g3 . . . that are arranged in chronological order is a video of 1920×1080/240i, which makes ¼ slow reproduction video when displayed 60 fields per second.

As described above, interlaced images are processed in the third embodiment instead of progressive images. However, the same effect as the first embodiment can be obtained. In other words, it is possible to reduce the image transfer speed from the imaging device, coding speed, and image recording speed that are necessary for capturing at high speed.

### Fourth Embodiment

The second embodiment describes a case where a method of skipping pixels per line or column is used, and the third embodiment describes a case where the interlaced images are processed. The fourth embodiment is a combination of the second embodiment and the third embodiment.

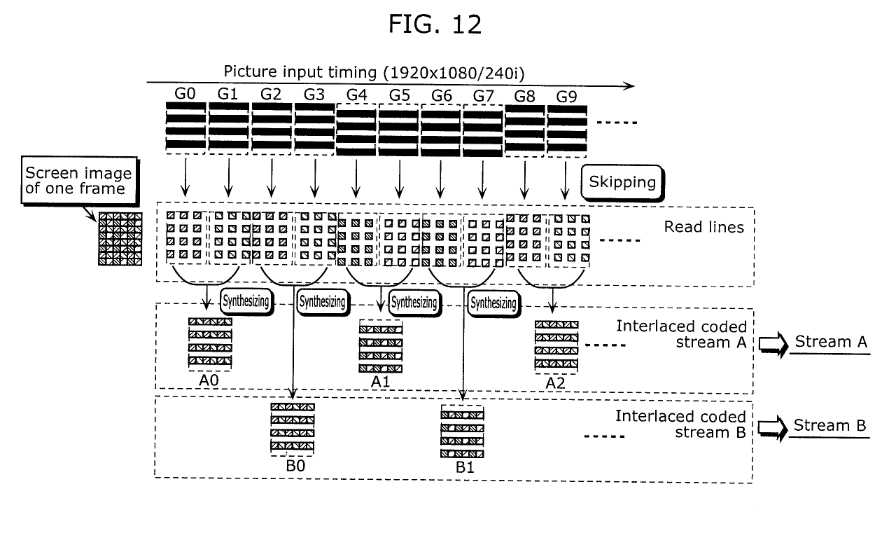

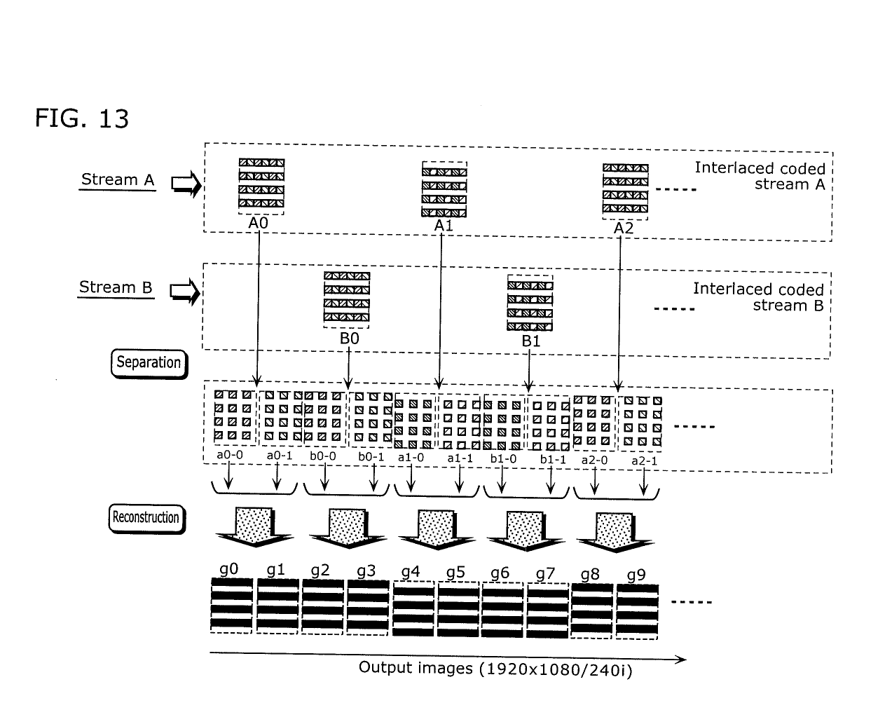

More specifically, FIG. 12 illustrates an image transform method according to the fourth embodiment, and FIG. 13 describes an image reconstructing method according to the fourth embodiment. As illustrated in these diagrams, even when the interlaced images are to be processed, it is possible to use the method of skipping pixels per line or column. Detailed description for the other points is omitted here, since they are identical to the second embodiment or the third embodiment.

### Fifth Embodiment

In the first embodiment, all of the 1280×720 pixels are read by the imaging device 110 for generating the input image. However, pixels that the image transforming unit 130 does not use are also included. Thus, in the fifth embodiment, the imaging device 110 is controlled such that the imaging device 110 does not read the pixels that the image transforming unit 130 does not use. The following describes the structure of the image recording device 100 according the fifth embodiment focusing on the difference from the first embodiment.

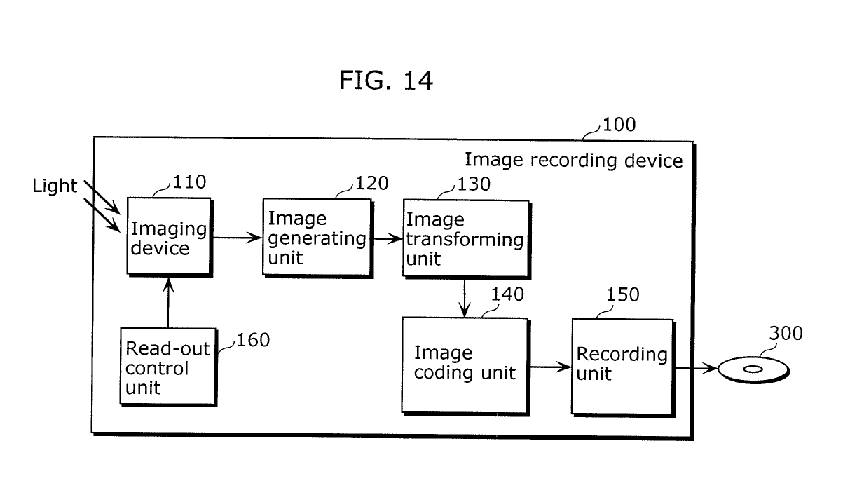

FIG. 14 is a block diagram of the image recording device 100 according to the fifth embodiment of the present invention.

The image recording device 100 has the structure identical to FIG. 2 except that the read-out control unit 160 is added. The read-out control unit 160 controls the imaging device 100 such that the imaging device 110 does not read the pixels that the image transforming unit 130 does not use. More specifically, the read-out control unit 160 is capable of selecting the pixels read from the imaging device 110. The following describes the operation of the read-out control unit 160 when generating a stream illustrated in FIG. 3.

First, the read-out control unit 160 controls the imaging device 110 such that all of the pixels in the angle of view of 1280×720 when reading pixels from the imaging device 110 to generate the input frame G0. The imaging device 110 follows the instruction, and outputs all of the 1280×720 pixels to the image generating unit 120.

Furthermore, the read-out control unit 160 controls the imaging device 110 to read the pixel lines 0, 4, 8 . . . 716 among the pixels in the 1280×720 angle of view, when reading the pixels from the imaging device 110 to generate the input frame G1. The imaging device 110 follows the instruction and outputs the pixels in the pixel lines 0, 4, 8 . . . 716 to the image generating unit 120.

Similarly, when reading the pixels from the imaging device 110 to generate the input frame G2, the read-out control unit 160 controls the imaging device 110 to read the pixels in the pixel lines 1, 5, 9 . . . 717. When reading the pixels from the imaging device 110 to generate the input frame G3, the read-out control unit 160 controls the imaging device 110 to read the pixels in the pixel lines 2, 6, 10 . . . 718. When reading the pixels from the imaging device 110 to generate the input frame G4, the read-out control unit 160 controls the imaging device 110 to read the pixels in the pixel lines 3, 7, 11 . . . 719.

As described above, the read-out control unit 160 according to the fifth embodiment controls the imaging device 110 such that the imaging device 110 does not read the pixels that the image transforming unit 130 does not use. With this, the number of pixels to be read out is reduced compared to the case where all of the 1280×720 pixels are read to generate an input image, thereby reducing the image transfer speed from the imaging device 110. Furthermore, since the number of pixels to be read out is reduced, the consumption power of the image recording device 100 is reduced as well.

### Sixth Embodiment

Not just the image coding units compliant with H.264, regular image coding units are configured to code only one moving picture. In contrast, an image recording device 100 including two coding units each of which codes one moving picture is used in the sixth embodiment. The following describes the structure of the image recording device 100 according the sixth embodiment focusing on the difference from the first embodiment.

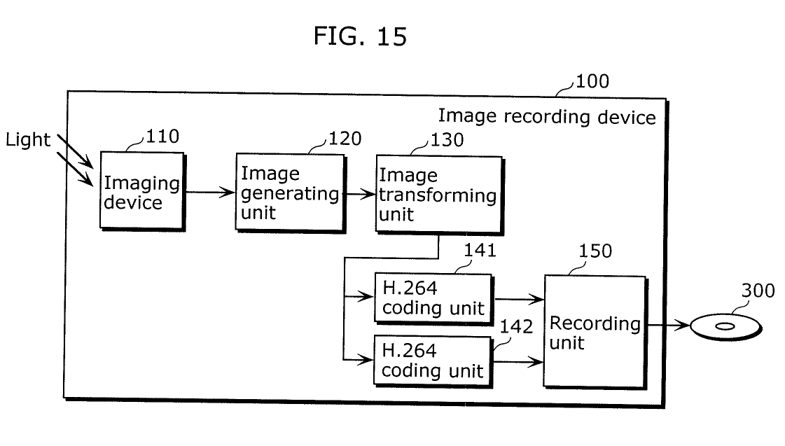

FIG. 15 is a block diagram of the image recording device 100 according to the sixth embodiment of the present invention.

As illustrated in FIG. 15, the image recording device 100 according to the sixth embodiment is characterized by dividing a video at high frame rate into two moving pictures. Here, the two moving pictures to be coded have the same format. In order to simultaneously code the two moving pictures, an H.264 image coding unit 141 and an H.264 image coding unit 142 are provided as image coding units. Since the structure of the H.264 image coding unit 141 and the H.264 image coding unit 142 are identical, and thus the manufacturing process of the image recording device 100 would not become particularly complex.

As described above, the video at high frame rate may be divided into two moving pictures and coded. Furthermore, the structure of the H.264 image coding unit 141 and the H.264 image coding unit 142 are identical. Thus, there is another effect that the manufacturing of the image recording device 100 would not become particularly complex.

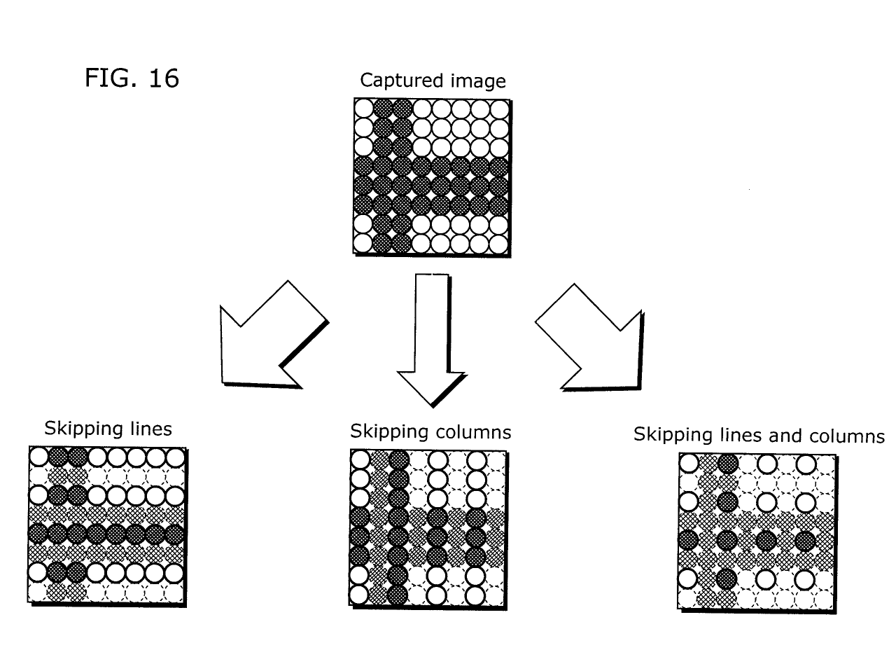

Note that, although skipping by lines is described in the first embodiment and skipping by lines and columns is described in the second embodiment, the method for skipping the pixels is not limited to these embodiments. In other words, the skipping methods for pixels may be any of skipping by line, skipping by columns, or skipping by lines and columns, as illustrated in FIG. 16, or another skipping method may be used. Thus, the skipping method may not be particularly limited.

Furthermore, the present invention may not only be implemented as the image recording device 100 and the image reproduction device 200, but also as a program causing the computer to execute the image recording method and the image reproduction method.

Furthermore, the image recording device 100 and the image reproduction device 200 in the embodiments may be implemented using LSI, which is a typical integrated circuit. In this case, the LSI may constitute in one chip, or multiple chips. For example, the functional block other the memory may be constituted in a single-chip LSI. Furthermore, here, LSI is mentioned but there are instances where, due to a difference in the degree of integration, the designations IC, system LSI, super LSI, and ultra LSI are used.

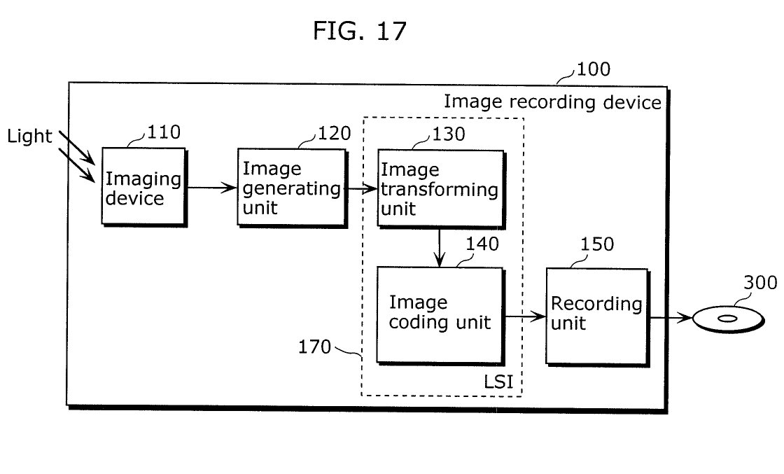

FIG. 17 illustrates an example of the functional structure of the image recording device 100 implemented as an LSI 170. The LSI 170 illustrated in FIG. 17 is an example of the image recording integrated circuit according to the present invention, and constitutes a single-chip LSI.

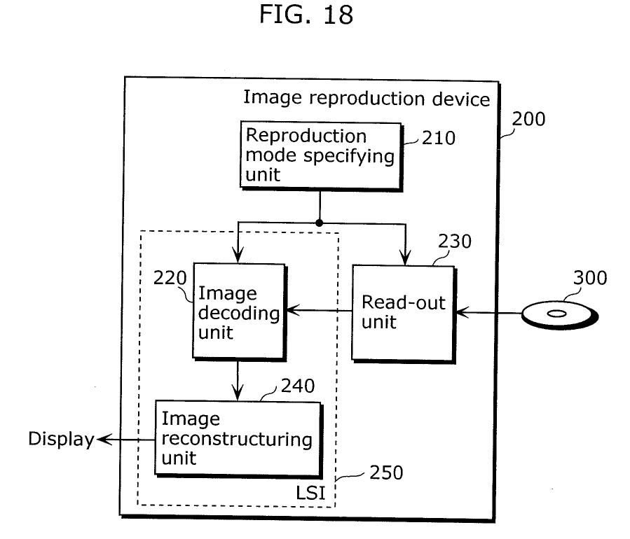

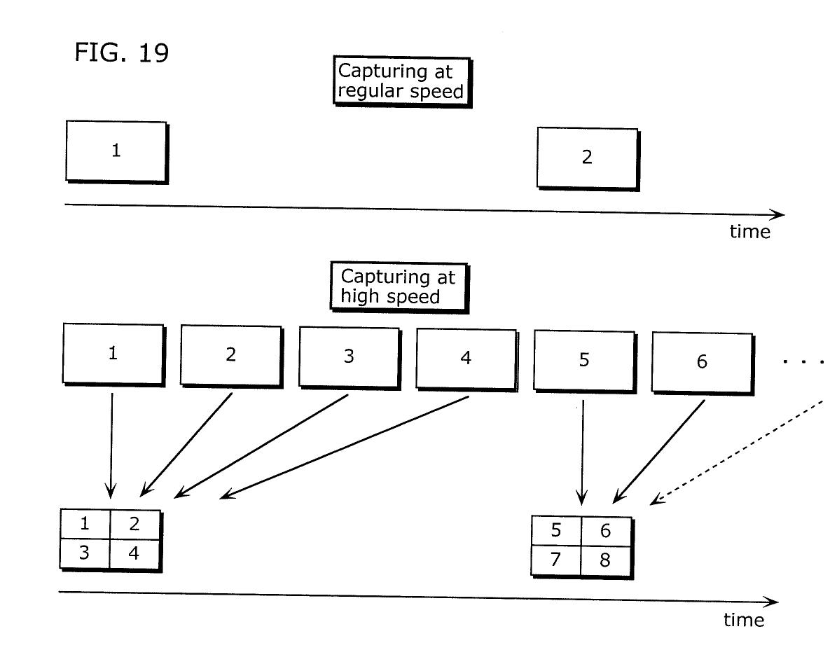

FIG. 18 illustrates an example of the functional structure of the image recording device 200 implemented as an LSI 250. The LSI 250 illustrated in FIG. 18 is an example of the image decoding integrated circuit according to the present invention, and constitutes a single-chip LSI.

Note that, the functional structure of the LSI 170 and the LSI 250 illustrated in FIG. 17 and FIG. 18, respectively, may be different from the functional structure illustrated in FIG. 17 and FIG. 18. For example, the LSI 170 may further include a part of or both of the image generating unit 120 and the recording unit 150. Similarly, the LSI 250 may further include a part of or both of the reproduction mode specifying unit 210 and the read-out unit 230.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears thorough progress in semiconductor technology or other derived technology, that technology can naturally be used to carry out integration of the constituent elements. For example, biotechnology is anticipated to apply.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to camcorders and DVD players that are necessary to reduce the image transfer speed from the imaging device, coding speed, and image recording speed that are necessary for capturing at high speed.

1. An image recording device which records an input image, said image recording device comprising:
an image generating unit configured to generate the input image based on input electric signal;
an image transforming unit configured to generate a group of first frames which is a moving picture that can be independently reproduced, by extracting frames at a predetermined time interval from frames included in the input image generated by said image generating unit and by arranging, in chronological order, the extracted frames, and to generate a group of second frames using frames that are not in the group of first frames but are in the frames included in the input image;
an image coding unit configured (i) to code the group of first frames generated by said image transforming unit and to output a first stream, and (ii) to code the group of second frames generated by said image transforming unit and to output a second stream; and
a recording unit configured to record the first stream and the second stream coded by said image coding unit on a recording medium.

2. The image recording device according to claim 1,
wherein said image transforming unit is configured to arrange, in chronological order, synthesized frames to generate the group of second frames, each of the synthesized frames being synthesized from pixels extracted from different regions of frames that are between temporally adjacent frames of the group of first frames.

3. The image recording device according to claim 2,
wherein said image transforming unit is configured to synthesize each of the synthesized frames from pixels that are not skipped when skipping pixels in the frames at least one of per line and per column.

4. The image recording device according to claim 2,
wherein the input image is a progressive image.

5. The image recording device according to claim 1,
wherein said image transforming unit is configured (i) to extract N frames for each N frames from the frames, where N being a natural number, to synthesize each of first synthesized frames from the N frames that are temporally successive, and to arrange, in chronological order, the first synthesized frames to generate the group of first frames, and (ii) to synthesize each of second synthesized frames from N temporally successive frames among frames that are not in the group of first frames but are in the frames included in the input image, and to arrange, in chronological order, the second synthesized frames to generate the group of second frames.

6. The image recording device according to claim 5,
wherein the input image is an interlaced image.

7. The image recording device according to claim 1,
wherein the group of first frames and the group of second frames have an identical screen size and an identical frame rate.

8. A camera comprising:
said image recording device according to claim 1; and
an imaging unit configured to convert light into electric signals and output the electric signals to said image generating unit.

9. The camera according to claim 8,
wherein said image transforming unit is configured to arrange, in chronological order, synthesized frames to generate the group of second frames, each of the synthesized frames being synthesized from pixels extracted from different regions of frames that are between temporally adjacent frames of the group of first frames.

10. The camera according to claim 9, further comprising
a read-out control unit configured to control said imaging unit to extract only electric signals corresponding to pixels composing the synthesized frame, from each of frames that are not in the group of first frames but are in the frames included in the input image.

11. An image reproduction device which reproduces the image recorded by said image recording device according to claim 1, said image reproduction device comprising:
a reproduction mode specifying unit configured to specify either regular reproduction or slow reproduction as a reproduction mode;
a read-out unit configured to read a stream from the recording medium;
a decoding unit configured to decode the stream read by said read-out unit; and
an image reconstructuring unit configured to reproduce a group of frames decoded by said decoding unit,
wherein, when said reproduction mode specifying unit specifies regular reproduction,
said read-out unit reads the first stream recorded on the recording medium,
said decoding unit decodes the first stream read by said read-out unit, and
said image reconstructuring unit reproduces the group of first frames decoded by said decoding unit without any change, and
when said reproduction mode specifying unit specifies slow reproduction,
said read-out unit reads both the first stream and the second stream recorded on the recording medium,
said decoding unit separately decodes the first stream and the second stream that are read by said read-out unit, and
said image reconstructing unit arranges, in chronological order, the frames included in the group of first frames and the group of second frames that are decoded by said decoding unit, and reproduces the arranged frames.

12. An image recording method for recording an input image, said image recording method comprising:
generating the input image based on input electric signal;
generating a group of first frames which is a moving picture that can be independently reproduced, by extracting frames at a predetermined time interval from frames included in the input image generated by said image generating unit and by arranging, in chronological order, the extracted frames, and generating a group of second frames using frames that are not in the group of first frames but are in the frames included in the input image;
(i) coding the group of first frames generated by said image transforming unit and outputting a first stream, and (ii) coding the group of second frames generated in said generating, and outputting a second stream; and
recording the first stream and the second stream coded in said generating on a recording medium.

13. An image reproduction method for reproducing the image recorded by said image recording device according to claim 1, said image reproduction method comprising:
specifying either regular reproduction or slow reproduction as a reproduction mode;
reading a stream from the recording medium;
decoding the stream read in said reading; and
reproducing a group of frames decoded in said decoding,
wherein, when regular reproduction is specified in said specifying,
the first stream recorded on the recording medium is read,
the first stream read in said reading is decoded,
the group of first frames decoded in said decoding is reproduced without any change, and
when slow reproduction is specified in said specifying,
both the first stream and the second stream recorded on the recording medium are read,
the first stream and the second stream that are read by said read-out unit are decoded separately, and
the frames included in the group of first frames and the group of second frames that are decoded in said decoding are arranged in chronological order and the arranged frames are reproduced.

14. A program causing a computer to record an input image, said program causing the computer to execute:
generating the input image based on input electric signal;
generating a group of first frames which is a moving picture that can be independently reproduced, by extracting frames at a predetermined time interval from frames included in the input image generated by said image generating unit and by arranging, in chronological order, the extracted frames, and generating a group of second frames using frames that are not in the group of first frames but are in the frames included in the input image;
(i) coding the group of first frames generated by said image transforming unit and outputting a first stream, and (ii) coding the group of second frames generated in said generating, and outputting a second stream; and
recording the first stream and the second stream coded in said generating on a recording medium.

15. A program causing a computer to reproduce the image recorded by said image recording device according to claim 1, said program causing the computer to execute:
specifying either regular reproduction or slow reproduction as a reproduction mode;
reading a stream from the recording medium;
decoding the stream read in said reading; and
reproducing a group of frames decoded in said decoding,
wherein, when regular reproduction is specified in said specifying,
the first stream recorded on the recording medium is read,
the first stream read in said reading is decoded,
the group of first frames decoded in said decoding is reproduced without any change, and
when slow reproduction is specified in said specifying,
both the first stream and the second stream recorded on the recording medium are read,
the first stream and the second stream that are read by said read-out unit are decoded separately, and
the frames included in the group of first frames and the group of second frames that are decoded in said decoding are arranged in chronological order and the arranged frames are reproduced.

16. An integrated circuit which codes an input image, said integrated circuit comprising:
an image transforming unit configured to generate a group of first frames which is a moving picture that can be independently reproduced, by extracting frames at a predetermined time interval from frames included in the input image and by arranging, in chronological order, the extracted frames, and to generate a group of second frames using frames that are not in the group of first frames but are in the frames included in the input image;
an image coding unit configured (i) to code the group of first frames generated by said image transforming unit and to output a first stream, and (ii) to code the group of second frames generated by said image transforming unit and to output a second stream.

17. An integrated circuit which reproduces the image recorded by said image recording device according to claim 1, said integrated circuit comprising:
a decoding unit configured to decode an input stream; and
an image reconstructuring unit configured to reproduce a group of frames decoded by said decoding unit,
wherein, when regular reproduction is specified upon input of the first stream recorded on the recording medium,
said decoding unit decodes the first stream read by said read-out unit,
said image reconstructuring unit reproduces the group of first frames decoded by said decoding unit without any change, and
when slow reproduction is specified upon input of the first stream and a second stream that are recorded on the recording medium,
said decoding unit separately decodes the first stream and the second stream that are read by said read-out unit, and
said image reconstructing unit arranges, in chronological order, the frames included in the group of first frames and the group of second frames that are decoded by said decoding unit, and reproduces the arranged frames.
